(19) United States
(12) Patent Application Publication
(10) Pub. No.: US 2025/0139797 A1
(43) Pub. Date: May 1, 2025

(54) Image-Assisted Region Growing For Object Segmentation And Dimensioning

(71) Applicant: Zebra Technologies Corporation, Lincolnshire, IL (US)

(72) Inventors: M. P. Hiranya Nuwan Kumara, Nupe Matara (LK); Sanduni Karunatilaka, Kottawa (LK); Rochana Pathiraja, Dampelessa (LK); Michael Wijayantha Medagama, Nawala (LK); Samitha Wijesundera, Kandy (LK)

(21) Appl. No.: 18/603,500

(22) Filed: Mar. 13, 2024

Related U.S. Application Data
(60) Provisional application No. 63/546,439, filed on Oct. 30, 2023.

(51) Int. Cl. G06T 7/50; G06T 7/12; G06V 10/25; G06V 10/44

(52) U.S. Cl. CPC G06T 7/50; G06T 7/12; G06V 10/25; G06V 10/44

(57) ABSTRACT

A method includes: capturing (i) depth data depicting an object, and (ii) image data depicting the object; determining a mask corresponding to the object from the image data; identifying candidate points in the depth data based on the mask; for each of a plurality of points in the depth data, determining an indicator based on (i) whether the point is one of the candidate points, and (ii) a distance between the point and a reference feature in the depth data; assigning each of the plurality of points having an indicator that exceeds a threshold to a set of points representing the object; and dimensioning the object based on the set of points.

### CROSS-REFERENCE TO RELATED APPLICATIONS

This application claims priority from U.S. Provisional Patent Application No. 63/546,439, filed Oct. 30, 2023, the contents of which is incorporated herein by reference.

### BACKGROUND

Depth sensors such as time-of-flight (ToF) sensors can be deployed in mobile devices such as handheld computers, and employed to capture point clouds of objects (e.g., boxes or other packages), from which dimensions of the objects can be derived. Inaccurate segmentation of an object from surrounding surfaces may lead to reduced dimensioning accuracy.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a computing device for determining attributes of an object.

FIG. 2 is a flowchart of a method of image-assisted region growing for object segmentation.

FIG. 3 is a diagram illustrating a performance of block 205 of the method of FIG. 2.

FIG. 4 is a diagram illustrating an example performance of blocks 210 and 215 of the method of FIG. 2.

FIG. 5 is a diagram illustrating a example performance of blocks 225 and 230 of the method of FIG. 2.

FIG. 6 is a diagram illustrating a example performance of block 255 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: capturing (i) depth data depicting an object, and (ii) image data depicting the object; determining a mask corresponding to the object from the image data; identifying candidate points in the depth data based on the mask; for each of a plurality of points in the depth data, determining an indicator based on (i) whether the point is one of the candidate points, and (ii) a distance between the point and a reference feature in the depth data; assigning each of the plurality of points having an indicator that exceeds a threshold to a set of points representing the object; and dimensioning the object based on the set of points.

Additional examples disclosed herein are directed to a computing device comprising: a sensor; and a processor configured to: capture, via the sensor, (i) depth data depicting an object, and (ii) image data depicting the object; determine a mask corresponding to the object from the image data; identify candidate points in the depth data based on the mask; for each of a plurality of points in the depth data, determine an indicator based on (i) whether the point is one of the candidate points, and (ii) a distance between the point and a reference feature in the depth data; assign each of the plurality of points having an indicator that exceeds a threshold to a set of points representing the object; and dimension the object based on the set of points.

Further examples disclosed herein are directed to a non-transitory computer-readable medium storing instructions executable by a processor of a computing device to: capture, via a sensor, (i) depth data depicting an object, and (ii) image data depicting the object; determine a mask corresponding to the object from the image data; identify candidate points in the depth data based on the mask; for each of a plurality of points in the depth data, determine an indicator based on (i) whether the point is one of the candidate points, and (ii) a distance between the point and a reference feature in the depth data; assign each of the plurality of points having an indicator that exceeds a threshold to a set of points representing the object; and dimension the object based on the set of points.

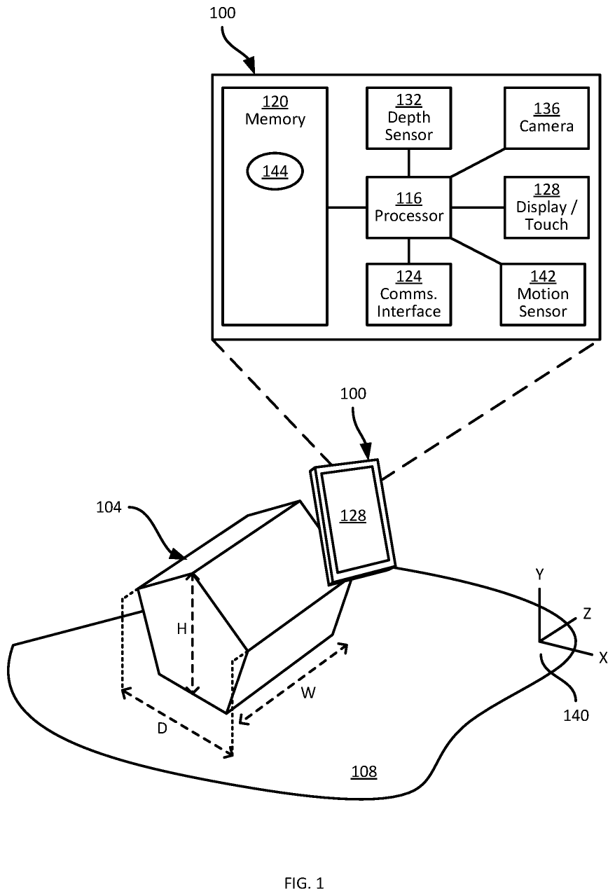

FIG. 1 illustrates a computing device 100 configured to capture sensor data depicting a target object 104 (e.g., a parcel or the like), also referred to herein as the object 104, within a field of view (FOV) of one or more sensors of the device 100. The computing device 100, in the illustrated example, is a mobile computing device such as a tablet computer, smartphone, or the like. The computing device 100 can be manipulated by an operator thereof to place the target object 104 within the FOV(s) of the sensor(s), in order to capture sensor data for subsequent processing as described below. In other examples, the computing device 100 can be implemented as a fixed computing device, e.g., mounted adjacent to an area in which objects 104 are placed and/or transported (e.g., a staging area, a conveyor belt, a storage container, or the like).

The object 104, in this example, has a non-cuboid shape. In particular, the object 104 is a pentagonal prism. The object 104 can have a wide variety of other shapes, however, including cuboid shapes and irregular shapes. The object 104 is shown resting on a support surface 108 (e.g., a floor, table, conveyor, or the like).

The sensor data captured by the computing device 100 includes depth data, e.g., in the form of a point cloud and/or depth image. The depth data includes a plurality of depth measurements, also referred to in the discussion below as points. Each point of the depth data defines a three-dimensional position of a corresponding point on the object 104. The sensor data captured by the computing device 100 also includes image data, such as a two-dimensional (2D) image depicting the object 104. The 2D image can include a two-dimensional array of pixels, each pixel containing a color and/or brightness (e.g., intensity) value. For instance, the image can be a color image in which each pixel in the array contains a plurality of color component values (e.g., values for red, green and blue levels, or for any other suitable color model). The device 100 (or in some examples, another computing device such as a server, configured to obtain the sensor data from the device 100) is configured to segment the object 104 from the sensor data, and can perform further processing on the segmented sensor data.

For example, following segmentation, the device 100 can determine dimensions of the object 104, such as a width “W”, a depth “D”, and a height “H” of the object 104. As seen in FIG. 1, when the object 104 is non-cuboid, the dimensions of the target object 104 need not align with physical edges of the object 104. For example, dimensions of a non-cuboid object can be the width, depth, and height of a cuboid space encompassing the object 104, or the dimensions can include various other measurements of the object 104. For example, a minimum bounding box encompassing the object 104 can be determined, and the width, depth, and height of that bounding box can be used as dimensions for the object 104. As illustrated in FIG. 1, the height H of the object 104 is shown as a distance, perpendicular to the support surface 108 (which is horizontal in this example), between the support surface 108 and an apex of the object 104. Further, the depth D is a distance parallel to the support surface extending between opposing edges of the object 104.

The dimensions determined from the captured data can be employed in a wide variety of downstream processes, such as optimizing loading arrangements for storage containers, pricing for transportation services based on parcel size, and the like. The computing device 100 can also be configured to determine other attributes of the object 104 in addition to or instead of the dimensions noted above. For example, the computing device 100 can be configured to classify the object 104 into various types based on captured sensor data, to detect a location of the object 104, or the like.

Certain internal components of the device 100 are also shown in FIG. 1. For example, the device 100 includes a processor 116 (e.g., a central processing unit (CPU), graphics processing unit (GPU), and/or other suitable control circuitry, microcontroller, or the like). The processor 116 is interconnected with a non-transitory computer readable storage medium, such as a memory 120. The memory 120 includes a combination of volatile memory (e.g. Random Access Memory or RAM) and non-volatile memory (e.g. read only memory or ROM, Electrically Erasable Programmable Read Only Memory or EEPROM, flash memory). The memory 120 can store computer-readable instructions, execution of which by the processor 116 configures the processor 116 to perform various functions in conjunction with certain other components of the device 100. The device 100 can also include a communications interface 124 enabling the device 100 to exchange data with other computing devices, e.g. via various networks, short-range communications links, and the like.

The device 100 can also include one or more input and output devices, such as a display 128, e.g., with an integrated touch screen. In other examples, the input/output devices can include any suitable combination of microphones, speakers, keypads, data capture triggers, or the like.

The device 100 further includes a depth sensor 132, controllable by the processor 116 to capture depth data such as a point cloud, depth image, or the like. The device 100 also includes an image sensor, also referred to as a camera 136, configured to capture image data, such as a two-dimensional color image, a two-dimensional intensity-based (e.g., grayscale) image, or the like. In some examples, the depth sensor 132 and the camera 136 can be implemented by a single sensor device configured to capture both depth measurements for generating point clouds, and color and/or intensity measurements for generating 2D images.

The depth sensor 132 can include a time-of-flight (ToF) sensor, e.g., mounted on a housing of the device 100, for example on a back of the housing (opposite the display 128, which is visible in FIG. 1) and having an optical axis that is substantially perpendicular to the display 128. A ToF sensor can include, for example, a emitter (e.g., a laser emitter) configured to illuminate a scene, and an image sensor configured to capture light from the emitter as reflected by the scene. The ToF sensor can further include a controller configured to determine a depth measurement for each captured reflection, according to the time difference between illumination pulses and reflections. Each depth measurement indicates a distance between the depth sensor 132 itself and the point in space where the reflection originated. Each depth measurement represents a point in a resulting point cloud. The depth sensor 132 and/or the processor 116 can be configured to convert the depth measurements into points in a three-dimensional coordinate system 140. Although the coordinate system 140 is shown with an origin on the support surface 108, a wide variety of other coordinate systems can also be used, e.g., with an origin at the depth sensor 132.

As will be apparent to those skilled in the art, the depth sensor 132 can also be configured to generate 2D images, e.g., by capturing reflections from emitted light and ambient light, and generating a two-dimensional array of pixels containing intensity values. For illustrative purposes, however, 2D images processed in the discussion below are captured by the camera 136, e.g., simultaneously with the capture of point clouds by the depth sensor 132. The camera 136 may, in some examples, produce a 2D image with a greater resolution than the depth sensor 132 (e.g., with a greater number of pixels representing a given portion of the scene). The points of the point cloud can be mapped to corresponding pixels of the 2D image according to a transform defined by calibration data for the sensors 132 and 136 (e.g., sensor extrinsic and intrinsic matrices).

The device 100 can also include a motion sensor 142, such as an inertial measurement unit (IMU) including one or more accelerometers and one or more gyroscopes. The motion sensor 142 can be configured to generate orientation and/or acceleration measurements for the device 100, e.g., indicating an angle of orientation of the device 100 relative to a gravity vector.

The memory 120 stores computer readable instructions for execution by the processor 116. In particular, the memory 120 stores a dimensioning application 144 which, when executed by the processor 116, configures the processor 116 to process one or more point clouds (e.g., one or more successive frames of depth measurements captured by the sensor 136 and converted to point clouds representing the object 104 at successive points in time) to detect the object 104 and determine dimensions (e.g., the width, depth, and height shown in FIG. 1) and/or other attributes of the object 104, such as an object type or class, an object location, or the like.

Detecting and dimensioning the object 104, and/or performing other processing to determine other attributes of the object 104, may involve segmenting the object 104 from the remainder of the depth and/or image data captured by the sensors 132 and 136. Segmentation of a point cloud, for example, can be performed by fitting planes to the point cloud and determining which planes correspond to surfaces of the object 104 rather than other surfaces (e.g., the support surface). Some approaches to segmentation, however, may erroneously include portions of the support surface 108 in the segmented portion of a point cloud corresponding to the object 104. For example, some segmentation processes include detecting an object in a 2D image, e.g., via a classification model, and segmenting the point cloud according to the image-based detection. The image-based detection, however, may not exactly align with the boundaries of the object 104, and the segmentation applied to the point cloud may therefore omit certain portions of the object 104, or include certain portions of the support surface 108. Such errors may be more common for non-cuboid objects, such as the object 104, and can lead to reduced dimensioning accuracy.

The device 100 is therefore configured to implement additional functionality to improve the accuracy of object segmentation from point clouds captured by the sensor 132. As discussed below, the device 100 can perform a preliminary object detection based on a 2D image, and use the preliminary image-based detection as an input to a region-growing process that applies additional segmentation criteria beyond the image-based detection. The functionality discussed herein can also be implemented via execution of the application 144 by the processor 116. In other examples, some or all of the functionality described herein can be performed via dedicated hardware (e.g., an application-specific integrated circuit or ASIC, or the like), or by a distinct computing device such as a server in communication with the device 100.

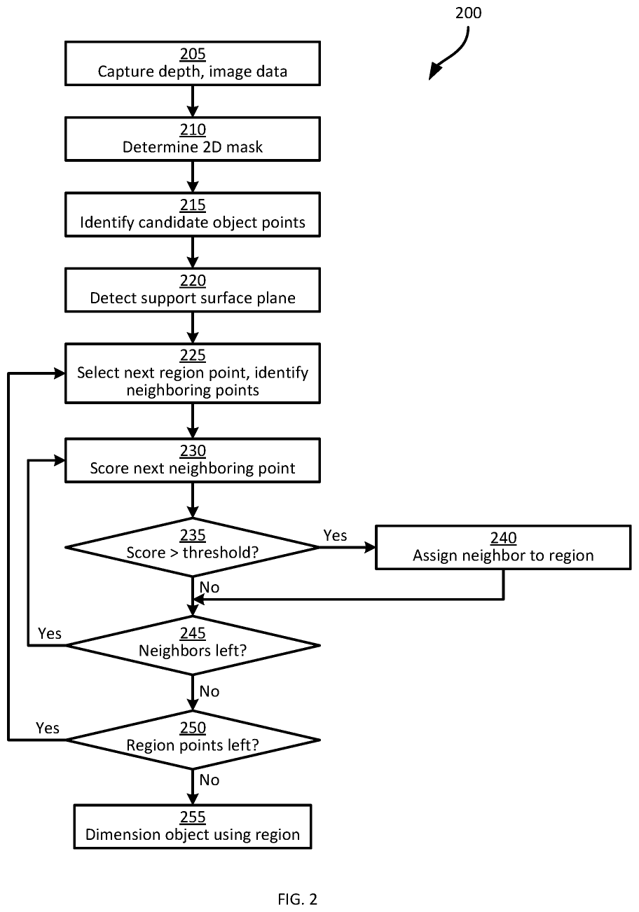

Turning to FIG. 2, a method 200 of image-assisted region growing for object segmentation is illustrated. The method 200 is described below in conjunction with its performance by the device 100, e.g., to detect the object 104 and in some cases, dimension the object 104 (although various other downstream processing actions may also be performed, in addition to or instead of dimensioning). It will be understood from the discussion below that the method 200 can also be performed by a wide variety of other computing devices including or connected with sensor assemblies functionally similar to the sensors 132 and 136.

At block 205, the device 100 is configured, e.g., via control of the depth sensor 132 and the camera 136 by the processor 116, to capture depth data such as a point cloud depicting the object 104, and image data such as a two-dimensional color image depicting the object 104. The point cloud and 2D image may also depict a portion of the support surface 108. The device 100 can, for example, be positioned relative to the object 104 as shown in FIG. 1, to capture a point cloud and an image depicting at least certain surfaces of the object 104. The point cloud and the 2D image are captured substantially simultaneously, e.g., by triggering the depth sensor 132 and the camera 136 at substantially the same time. In some examples, in which the depth sensor 132 and the camera 136 are implemented as a single sensor, simultaneous capture of the 2D image and the point cloud can be implemented by triggering such a combined sensor.

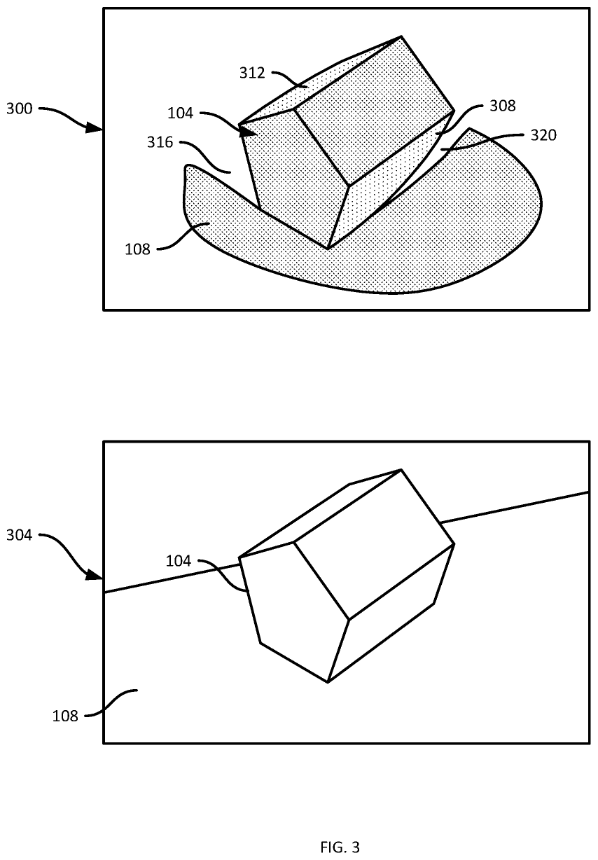

FIG. 3 illustrates an example point cloud 300 and an example image 304 captured at block 205. The point cloud 300 defines a plurality of points each having three-dimensional positions, e.g., specified in the coordinate system 140. Although solid outlines are shown for the object 104 and a portion of the support surface 108 for clarity, it will be understood that in practice, the point cloud 300 does not include such outlines, object boundaries, or the like. In addition, as shown in FIG. 3, the point cloud 300 may include regions of lower point density, such as on the faces 308 and 312 of the object 104, e.g., as a result of the angles of those faces relative to the sensor 136. As also seen in FIG. 3, the faces 308 and 312 and/or the support surface 108 may be incompletely represented due to line-of-sight obstructions or the like. For example, an area 316 and an area 320 of the support surface 108 may not be represented in the point cloud 300, because the areas 316 and 320 are obstructed from view to the sensor 136 by the object 104. The image 304, as seen in FIG. 3, may not be subject to the above artifacts.

Returning to FIG. 2, the device 100 is configured to determine a mask corresponding to the object 104, from the 2D image 304. For example, the device 100 can be configured to execute an object localization and classification module, such as a You Only Look Once (YOLO) classifier, to segment the object 104 from the image 304. A wide variety of other classifiers can also be employed at block 210. The mask can include, for example, an indication of each pixel classified as depicting a part of the object 104.

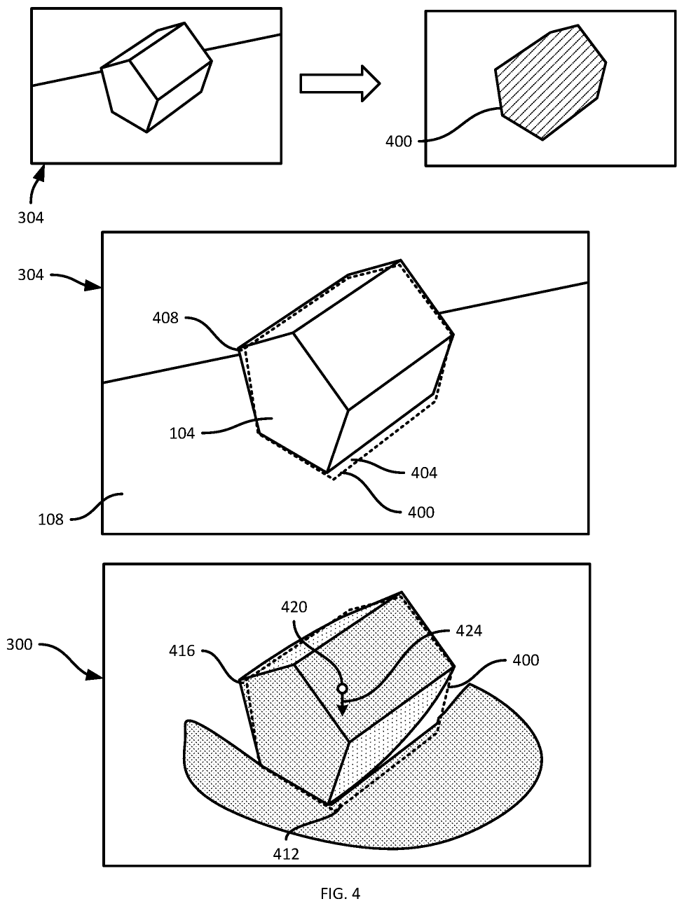

FIG. 4 illustrates an example mask 400 derived from the image 304. The mask 400 can be defined as a set of pixels of the image 304, as a polygon encompassing those pixels, or the like. The mask 400 may, however, not align exactly with the boundaries of the object 104. For example, FIG. 4 also shows the mask 400 overlaid on the image 304 in dashed lines, illustrating that the mask 400 encompasses a portion 404 of the support surface 108, and omits a portion 408 of the object 104. Segmenting the point cloud 300 based solely on the mask 400 may therefore lead to inaccuracies in segmentation and downstream processing such as dimensioning. The mask 400 can be processed to generate, for example, a boundary representing the outline of the mask 400, e.g., as a polygon with edges defined in 2D image coordinates.

At block 215, the device 100 is configured to identify points in the point cloud 300 that are contained within the mask 400. The points identified at block 215 can also be referred to as candidate points, as they are points that may represent the object 104, although it will be understood that some candidate points do not represent the object 104, and some other points outside the mask 400 may represent the object 104. Identifying the candidate points can include, for example, determining 2D image coordinates for each point in the point cloud 300 via calibration data (e.g., a transform matrix based on sensor parameters, including the relative physical positions of the sensors 132 and 136). Any point with image coordinates within the mask 400 is identified as a candidate point. For example, the device 100 can maintain a list of the candidate points (e.g., a list of indices, coordinate sets, or the like). In other examples, the device 100 can append metadata to the candidate points in the point cloud, such as a flag indicating that a given point is (or is not) a candidate point. As seen in the lower portion of FIG. 4, points of the point cloud 300 that fall within the mask 400 include a set of points 412 (corresponding to the portion 404 of the support surface 108) that are not actually part of the object 104. Further, certain points 416 that are actually part of the object 104 (corresponding to the portion 408) are not indicated as candidate points.

The device 100 can further determine a centroid 420 of the candidate points. The centroid 420 is not the center of mass of the candidate points in this example, because the center of mass of the object 104 is unlikely to represented by a point in the point cloud 300. The centroid 420 is instead a point on a surface of the object 104, e.g., determined by determining the centroid of the mask 400 (in two dimensions), and determining which point of the point cloud 300 corresponds to that centroid. In some examples, the device 100 can also transform the point cloud 300, e.g., to reduce the computational complexity of subsequent operations. For example, the device 100 can obtain a gravity vector 424 from the motion sensor 142. The device 100 can translate the point cloud 300 to place the centroid 420 at the origin of the coordinate system 140, and rotate the point cloud 300 to align the gravity vector 424 with the Y axis of the coordinate system 140.

At block 220, the device 100 can be configured to detect the support surface 108, e.g., by determining a plane definition (e.g., a normal vector to the support surface 108) based in part on the candidate points from block 215. For example, the device 100 can be configured to generate a copy of the point cloud 300 and subtract the candidate points from the copy, and to then fit a plane to the remaining points. In some examples, the device 100 can be configured to subtract an expanded set of points, rather than subtracting the candidate points alone. For example, the device 100 can be configured to determine a minimum bounding box in the point cloud 300 that contains all the candidate points, and to expand the minimum bounding box by a predetermined amount (e.g., a predetermined distance, volume fraction, linear dimension fraction, or the like), to increase the likelihood that all points corresponding to the object 104 are subtracted, even if some points were not contained within the mask 400. In some examples, the minimum bounding box can be expanded by about 20 cm, although a wide variety of other margins can also be used.

At blocks 225 to 250, the device 100 is configured to segment the object 104 from the point cloud 300 by determining an indicator for each of a plurality of points, and assigning each of the plurality of points with an indicator that exceeds a threshold to a set of points representing the object. The indicators are determined for each point based on membership of that point in the candidate points (e.g., whether the point is one of the candidate points), and on at least one additional metric. The additional metric can be, for example, a distance between the point and a reference feature in the point cloud 300. Various examples of additional metrics are discussed below.

The performance of blocks 225 to 250, as will be apparent from the discussion below, implement a region growing process by which the device 100 begins with one or more seed points in the point cloud 300, and assigns further points to a region corresponding to the object 104 based on the above-mentioned indicators.

At block 225, the device 100 is configured to select a region point and identify neighboring points to the selected region point. Initially, the device 100 is configured to select a seed point, such as the centroid 420. The centroid 420 is selected as a seed point for the region because, being located in the middle of the candidate points, the centroid 420 has a high likelihood of representing part of the object 104. Neighboring points are identified, for example, by selecting any points in the point cloud 300 within a predetermined search radius of the centroid 420. In other examples, the device 100 can select seed points based on the center pixel of the camera 136 (e.g., independent of the position of the candidate points), instead of based on the centroid 420. For example, the device 100 can select a region with predetermined dimensions (e.g., 12 pixels wide and 6 pixels high, although a wide variety of other dimensions can also be used), and select any points in the point cloud corresponding to that region as seed points.

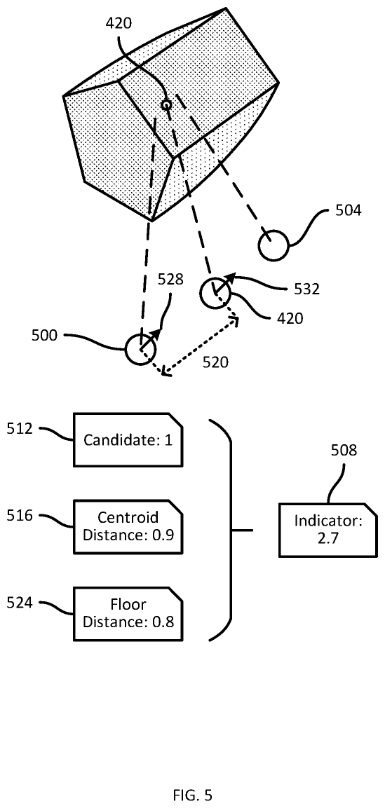

At block 230, the device 100 is configured to determine an indicator, also referred to as a score, for a selected one of the neighboring points from block 225. Turning to FIG. 5, an example performance of blocks 225 and 230 is shown. In particular, the device 100 selects the centroid 420 as a seed point, and identifies two neighboring points 500 and 504 as being within a threshold search radius of the centroid 420. The device 100 then determines, at block 230, an indicator for the point 500. The indicator defines a likelihood that the point 500 represents a part of the object 104. In this example, a higher indicator represents a greater likelihood, while a lower indicator represents a lower likelihood. In other examples, however, the generation of indicators can be configured such that lower indicators correspond to greater likelihoods of object representation.

An indicator 508 of the point 500 includes at least two components. In this example, the indicator 508 is generated from three components. A first component 512 is assigned based on whether the point 500 is one of the candidate points (e.g., contained within the mask 400). A value of “1” is assigned when the point 500 is a candidate point, and otherwise a value of “0” is assigned. As will be apparent, a wide variety of other scoring mechanisms can be employed beyond the binary example given above. A second component 516 is assigned based on a distance 520 between the point 500 and a first reference feature, in the form of the centroid 420, center pixel of the image, or the like. The second component 516 can be, for example, calculated as [1−(d/d max)], where d is the distance 520, and d max is the distance between the centroid 420 and the most distant point from the centroid 420 in the point cloud 300. In other words, the smaller the distance 520, the closer to a value of 1 is the component 516. A third component 524 is assigned based on a distance between the point 500 and the support surface 108, as detected at block 220 (e.g., a distance perpendicular to the support surface 108). The third component 524 can be determined similarly to the second component 516, e.g., using a ratio of the distance between the point 500 and the support surface 108 to the greatest distance between the support surface and another point in the point cloud 300.

Various other components can be used in addition to, or instead of, those mentioned above. For example, the device 100 can be configured to determine, for each point in the point cloud 300, a normal vector 528 corresponding to a normal of a surface defined by a given point and its neighbors. Another example component is based on a difference between the normal 528 of the point 500 (or any other point under evaluation) and a normal 532 of the centroid 420.

The indicator 508 can be determined by summing the components 512, 516, and 524. In other examples, weighting factors can be applied to the components 512, 516, and 524, e.g., to give more or less weight to a given component. Returning to FIG. 2, at block 235 the device 100 is configured to determine whether the indicator from block 230 exceeds a predetermined threshold. In the example illustrated in FIG. 5, the highest possible indicator value is 3, and the threshold may be set, for example, at 2 (although it will be understood that a wide variety of other indicator components can also be contemplated, and therefore a wide variety of other thresholds can also be used). When the determination at block 235 is affirmative (as in the case of the point 500), the device 100 is configured to assign the neighboring point under evaluation to the region corresponding to the object 104. For example, the device 100 can add the point 500 to a list, append a metadata attribute to the point 500, or the like. When the determination at block 235 is negative, or after performing block 240, the device 100 is configured to determine, at block 245, whether there are any neighboring points from block 225 left to process. In this example, the determination at block 245 is affirmative, as the point 504 has not yet been processed. The device 100 therefore returns to block 230, and repeats the scoring process above for the point 504.

When the determination at block 245 is negative, the device 100 proceeds to block 250 to determine whether any region points remain to be processed (e.g., for which neighboring points have not yet been identified and scored). For example, given that the point 500 was added to the region at block 240, the determination at block 250 is affirmative, because neighbors to the point 500 have not yet been identified and scored. The device 100 therefore returns to block 225, selecting the point 500 and identifying the neighbors of the point 500. As will now be apparent, the device 100 repeats blocks 225 to 250 until no further region points remain to be processed (e.g., until no further affirmative determinations at block 235 occur). When the determination at block 250 is negative, the device 100 proceeds to block 255.

At block 255, the device 100 can be configured to dimension the object 104 based on the set of points from the point cloud 300 assigned to the region grown via iterative performances of blocks 225 to 250. In other examples, the device 100 can determine other attributes of the object 104 in addition to or instead of dimensions.

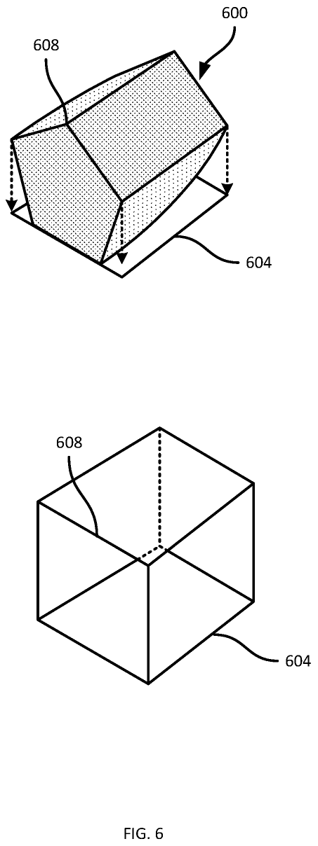

Various mechanisms for determining dimensions for the object 104 are contemplated. In some examples, the device 100 can be configured to implement a dimensioning process that is suitable for non-cuboid objects, such as the object 104 discussed herein. For example, turning to FIG. 6, the device 100 can be configured to project the set 600 of points resulting from the segmentation discussed above onto the plane of the support surface 108. An example projection 604 is shown in FIG. 6. In some examples, the device 100 can further transform the point cloud 300 such that the support surface 108 contains the origin of the coordinate system 140, and such that the XZ plane of the coordinate system 140 coincides with the plane of the support surface 108. In some examples, the device 100 can perform a noise removal operation prior to dimensioning.

In this example, the projection 604 is rectangular. In some examples, depending on the shape on the object 104, the projection 604 may not be rectangular. In such examples, the device 100 can determine a minimum 2D bounding box containing the projection 604 (e.g., via a rotating caliper operation), and proceed with the dimensioning process using that bounding box. The device 100 can then be configured to determine a height, e.g., by identifying the point in the set 600 with the largest Y coordinate, e.g., the vertex 608. The device 100 can then generate a three-dimensional bounding box, by extending the projection 604 (or the minimum bounding box noted above) to the height corresponding to the vertex 608. The three-dimensional box can then be dimensioned via any suitable cuboid dimensioning algorithm.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
capturing (i) depth data depicting an object, and (ii) image data depicting the object;
determining a mask corresponding to the object from the image data;
identifying candidate points in the depth data based on the mask;
for each of a plurality of points in the depth data, determining an indicator based on (i) whether the point is one of the candidate points, and (ii) a distance between the point and a reference feature in the depth data;
assigning each of the plurality of points having an indicator that exceeds a threshold to a set of points representing the object; and
dimensioning the object based on the set of points.

2. The method of claim 1, further comprising:
detecting, from the depth data, a surface supporting the object;
wherein the reference feature includes the surface.

3. The method of claim 2, wherein detecting the surface supporting the object includes:
selecting a portion of the depth data excluding the candidate points.

4. The method of claim 1, wherein determining the indicator includes:
determining a first indicator component based on whether the point is one of the candidate points;
determining a second indicator component based on the distance between the point and the reference feature; and
combining the first and second indicator components.

5. The method of claim 1, further comprising selecting the plurality of points by:
selecting a seed point from the candidate points;
selecting a first point neighboring the seed point;
determining the indicator for the first point; and
when the indicator exceeds the threshold, selecting a second point neighboring the first point.

6. The method of claim 5, wherein the seed point corresponds to a center of the image data.

7. The method of claim 6, wherein the reference feature includes the center of the image data.

8. The method of claim 1, wherein dimensioning the object includes:
determining a bounding box encompassing the set of points; and
determining dimensions of the bounding box.

9. A computing device comprising:
a sensor; and
a processor configured to:
capture, via the sensor, (i) depth data depicting an object, and (ii) image data depicting the object;
determine a mask corresponding to the object from the image data;
identify candidate points in the depth data based on the mask;
for each of a plurality of points in the depth data, determine an indicator based on (i) whether the point is one of the candidate points, and (ii) a distance between the point and a reference feature in the depth data;
assign each of the plurality of points having an indicator that exceeds a threshold to a set of points representing the object; and
dimension the object based on the set of points.

10. The computing device of claim 9, wherein the sensor includes a depth sensor and an image sensor.

11. The computing device of claim 9, wherein the processor is further configured to:
detect, from the depth data, a surface supporting the object;
wherein the reference feature includes the surface.

12. The computing device of claim 11, wherein the processor is configured to detect the surface supporting the object by:
selecting a portion of the depth data excluding the candidate points.

13. The computing device of claim 9, wherein the processor is configured to determine the indicator by:
determining a first indicator component based on whether the point is one of the candidate points;
determining a second indicator component based on the distance between the point and the reference feature; and
combining the first and second indicator components.

14. The computing device of claim 9, wherein the processor is further configured to select the plurality of points by:
selecting a seed point from the candidate points;
selecting a first point neighboring the seed point;
determining the indicator for the first point; and
when the indicator exceeds the threshold, selecting a second point neighboring the first point.

15. The computing device of claim 14, wherein the seed point corresponds to a center of the image data.

16. The computing device of claim 15, wherein the reference feature includes the center of the image data.

17. The computing device of claim 9, wherein the processor is configured to dimension the object by:
determining a bounding box encompassing the set of points; and
determining dimensions of the bounding box.

18. A non-transitory computer-readable medium storing instructions executable by a processor of a computing device to:
capture, via a sensor, (i) depth data depicting an object, and (ii) image data depicting the object;
determine a mask corresponding to the object from the image data;
identify candidate points in the depth data based on the mask;
for each of a plurality of points in the depth data, determine an indicator based on (i) whether the point is one of the candidate points, and (ii) a distance between the point and a reference feature in the depth data;
assign each of the plurality of points having an indicator that exceeds a threshold to a set of points representing the object; and
dimension the object based on the set of points.
